(19) United States
(12) Patent Application Publication
(10) Pub. No.: US 2005/0216683 A1
(43) Pub. Date: Sep. 29, 2005

(54) Disk array system and data transfer method thereof

(76) Inventor: Susumu Hirofuji, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/088,905

(22) Filed: Mar. 25, 2005

(30) Foreign Application Priority Data
Mar. 29, 2004 (JP) 2004-096469

(51) Int. Cl. G06F 12/16

(52) U.S. Cl. 711/162; 711/114

(57) ABSTRACT

A disk array system includes first and second transfer paths, a plurality of hard disks each having two connection ports connected to the first and second transfer paths, respectively, and a plurality of controllers connected to the first and second transfer paths, in which the first transfer path is connected to the plurality of hard disks and the plurality of controllers in common, and the second transfer path is divided as a transfer path for individual data transfer between the plurality of controllers and the plurality of hard disks.

### CROSS-REFERENCE TO RELATED APPLICATIONS

This application is based upon and claims the benefit of priority from prior Japanese Patent Application No. 2004-096469, filed Mar. 29, 2004, the entire contents of which are incorporated herein by reference.

### BACKGROUND OF THE INVENTION

1. Field of the Invention

The present invention relates to a disk array system and a data transfer method of the disk array system in which a hard disk drive (HDD) having two data transfer connection ports is shared by a plurality of controllers.

2. Description of the Related Art

A disk array system comprises a plurality of HDDs. The HDD can store data and enables replication of data between the HDDs. From this fact, as shown in FIG. 1A, a controller 51 writes data into an HDD 53 serving as a master system based on a request for writing data from a server 52 (S1), and then, the data stored in the HDD 53 can be copied to another HDD 54 serving as a copy system (S2). In FIG. 1A, reference symbol L1 designates a fiber channel (FC) loop.

In the disk array system, after the data stored in the HDD 53 is copied to the another HDD 54, the HDD 53 and the HDD 54 are logically disconnected from each other. Then, as shown in FIG. 1B, the controller 51 and another backup side controller 55 can share a data path 56. Reference symbol L2 designates an FC loop. Therefore, the another controller 55 can backup the data copied to the HDD 54 in a tape unit, etc. 57 (S3), and so-called server free backup can be achieved.

In the disk array system having the data replication function as described above, it is necessary to control a number of HDDs in order to install 100 or more HDDs and carry out data storage and replication of the stored data. However, after completing the replication of the stored data, the controller 55 backs up the data copied to the HDD 54 in the tape unit 57 without affecting the master system. Thus, in the case of reading out the copied data from the HDD 54, the controller 55 generally shares the data transfer path 56 for use in the master system as a data transfer path for reading the copied data.

Further, the following system is proposed as another conventional disk array system. A plurality of data disks and one hot spare disk are connected to a host unit via two array controllers. If a failure occurs with any of the data disks, the contents stored in the faulty data disk is restored from data stored in another normal data disk. Then, the restored data is stored in the hot spare disk serving as a substitute disk. In addition, during replacement of the hot spare disk, a backup unit can be mounted on a package slot of this hot spare disk (refer to FIG. 2 of Jpn. Pat. Appln. KOKAI Publication No. 10-260788).

In the above-described disk array system as well, in the case where the restored data is stored in the hot spare disk or in the case where the data is backed up in the backup unit instead of the host spare disk, it is necessary to backup the stored data by using a data transfer path of the data disk.

Therefore, in the disk array system as described above, a data write transfer of the master system by the controller 51 and a data readout transfer of the backup system by the controller 55 share the same data transfer path 56. Conventionally, the following problems have been pointed out.

(1) Since the controller 51 of the master system and the controller 55 of the backup system are connected to each other by one data transfer path 56, path performance of data transfer is determined depending on an upper limit of a bandwidth of the data transfer path 56. Thus, in the case where the master system and the backup system each have the performance which corresponds to the upper limit of the bandwidth of the data transfer path 56, an amount of data transfer in the master system and an amount of data transfer in the backup system are restricted to half of their best performance.

(2) In the case where there occurs a failure which affects the data transfer path 56 when data is backed up from the copy system HDD 54 to the tape unit 57, any operation of the master system and backup system is also affected, and reliability is significantly lowered.

In order to solve the above problem, as shown in FIG. 2, there is proposed a data transfer method for electrically disconnecting the data transfer path of the master system and backup system, thereby disabling sharing of the data transfer path. In this disk array system, first, the data stored in the master system HDD 53 is copied to the copy system HDD 54. Thereafter, the data transfer path 56 between the HDD 53 and the HDD 54 is disconnected. The controllers 51 and 55 are also disconnected from each other electrically completely. Then, data transfer between the master system and the backup system is individually carried out. In this manner, the controller 55 can read out the data copied to the HDD 54 and backup the readout data in the tape unit 57 without lowering the path performance of data transfer. In the case where the data transfer path 56 is electrically completely disconnected, the HDD 53 and the HDD 54 each serve as ends, so that an FC loop which loops at each of the ends is formed as indicated by the illustrated dashed line.

In the meantime, as shown in FIG. 2, after the data stored in the master system HDD 53 is copied to the copy system HDD 54, and then, the controllers 51 and 55 have been disconnected from each other electrically completely in addition to the data transfer path 56 between the HDD 53 and the HDD 54, in the case where a failure occurs with a master system data transfer path 56a or a copy system data transfer path 56b, the items of data handled between the controllers 51 and 55 do not coincide with each other. Accordingly, the controllers 51 and 55 cannot cooperate with each other, and the original normal data state cannot be restored.

In recent years, there has been developed an HDD having two ports for data transfer paths which can conform with a high speed serial interface standard, like an fiber channel (FC)-HDD. As described previously, however, if two data transfer paths connected to two ports, respectively, are completely disconnected from each other in the master system and backup system, data cannot be shared between the controllers in these systems. Thus, if a failure occurs, a normal original data configuration cannot be restored.

### BRIEF SUMMARY OF THE INVENTION

According to the present invention, there is provided a disk array system and a data transfer method of the disk array system capable of sharing data between controllers and capable of remarkably improving data transfer capability.

A disk array system according to a first aspect of the present invention is characterized by comprising: first and second transfer paths; a plurality of hard disks each having two connection ports connected to the first and second transfer paths, respectively; and a plurality of controllers connected to the first and second transfer paths, in which the first transfer path is connected to the plurality of hard disks and the plurality of controllers in common, and the second transfer path is divided as a transfer path for individual data transfer between the plurality of controllers and the plurality of hard disks.

The first transfer path is used for state monitoring of the plurality of hard disks shared among the plurality of controllers and replication of data stored in each of the hard disks.

A data transfer method to be applied to a disk array system in which a plurality of controllers share a plurality of hard disks each having first and second connection ports according to a second aspect of the present invention is characterized by comprising: dividing a first connection port of first and second data transfer paths independently connected to the first and second connection ports of the plurality of hard disks, respectively, the first connection port of the plurality of hard disk and the plurality of controllers being independently connected, respectively, via the first data transfer path, in which the first data transfer path is used for the controllers to transfer a large amount of data, respectively, and the second data transfer path is used for state monitoring of the plurality of HDDs shared among the controllers and replication of data stored in each of the HDDs.

According to the aspects of the invention, a corresponding controller can transfer a large amount of data by using a divided data transfer path, and data transfer capability can be remarkably improved. Further, between controllers, the other (second) data transfer path is used for state monitoring of a plurality of HDDs and data management including replication of data stored in each of the HDDs. In this manner, even if a failure occurs with any of the divided data transfer path systems, the processing of the other data transfer path can be inherited.

In addition, the controller connection ports of each controller use a first divided data transfer path and a second divided data transfer path. In addition, these connection ports each includes the plurality of controllers and the HDDs connected to the first and second divided data transfer paths. Further, an end portion is used as a loop back section, making daisy chain connection. Furthermore, the HDD connection ports connect the controllers and all the HDDs by using the other data transfer path. In this manner, data can be shared between the controllers, and the controllers each can be used for state monitoring of the plurality of HDDs via the other data transfer path and data management including replication of the data stored in each of the HDDs. Further, if a failure occurs with the first divided data transfer path or the second divided data transfer path, the processing can be inherited by using the other data transfer path.

According to the invention, there can be provided a data transfer method of a disk array system capable of sharing data between controllers and remarkably improving data transfer capability.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are views each illustrating data storage and backup processing in a conventional disk array system;

FIG. 2 is a view illustrating a configuration of disconnecting a data transfer path in the conventional disk array system during backup processing;

FIG. 3 is a block diagram depicting a configuration of a disk array system to which according to a first embodiment in a data transfer method according to the invention is applied;

FIG. 4 is a flow chart illustrating the data transfer method of the disk array system according to the invention;

FIGS. 5A to 5C are connection diagrams each depicting that two data transfer paths connected to two ports possessed by an HDD are utilized without being divided so that the HDD can be seen in the same state from each of the controllers;

FIG. 6 is a connection diagram depicting that, from among two data transfer paths connected to two ports possessed by an HDD, one of the data transfer paths is utilized after being divided, and the other data path is utilized without being divided so that the HDD can be seen in the same state from each of the controllers;

FIG. 7 is a connection diagram depicting that, from among two data transfer paths connected to two ports possessed by an HDD, one of the data transfer paths is utilized after being divided, and the other data path is utilized without being divided so that the HDD can be seen in the same state from each of the controllers;

FIGS. 8A and 8B are schematic block diagrams of a loop back circuit incorporated in each controller;

FIG. 9 is a data layout view of a setting table shown in FIGS. 8A and 8B; and

FIG. 10 is a view schematically illustrating an FC loop dividing section in particular from among constituent elements shown in FIGS. 8A and 8B.

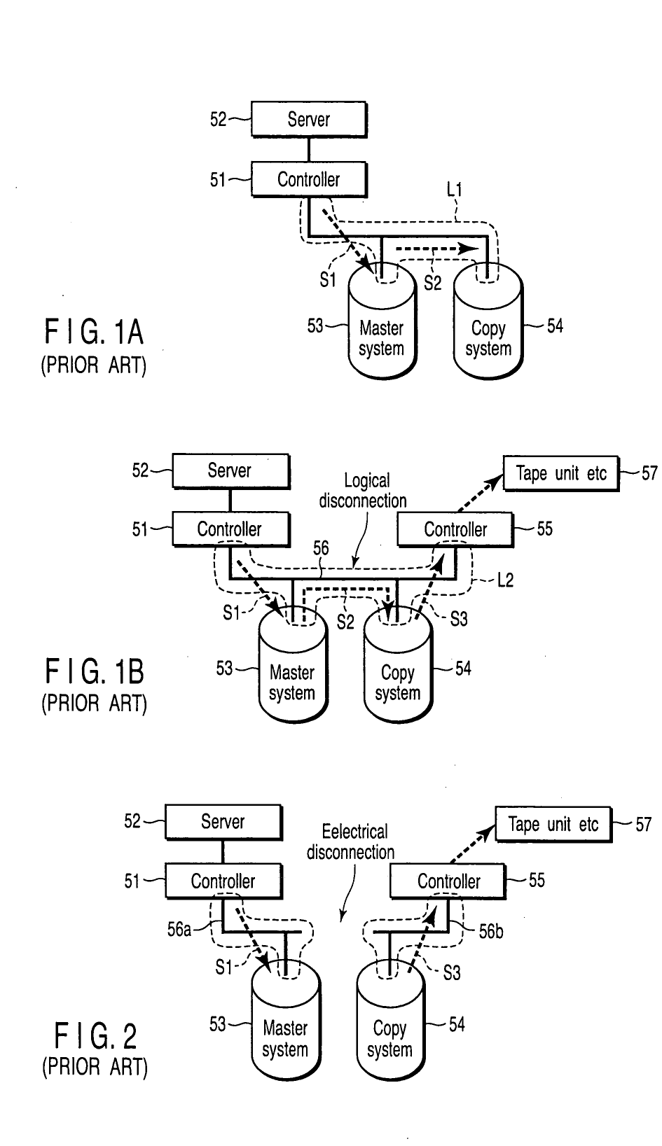

### DETAILED DESCRIPTION OF THE INVENTION

Hereinafter, embodiments of the present invention will be described with reference to the accompanying drawings.

### First Embodiment

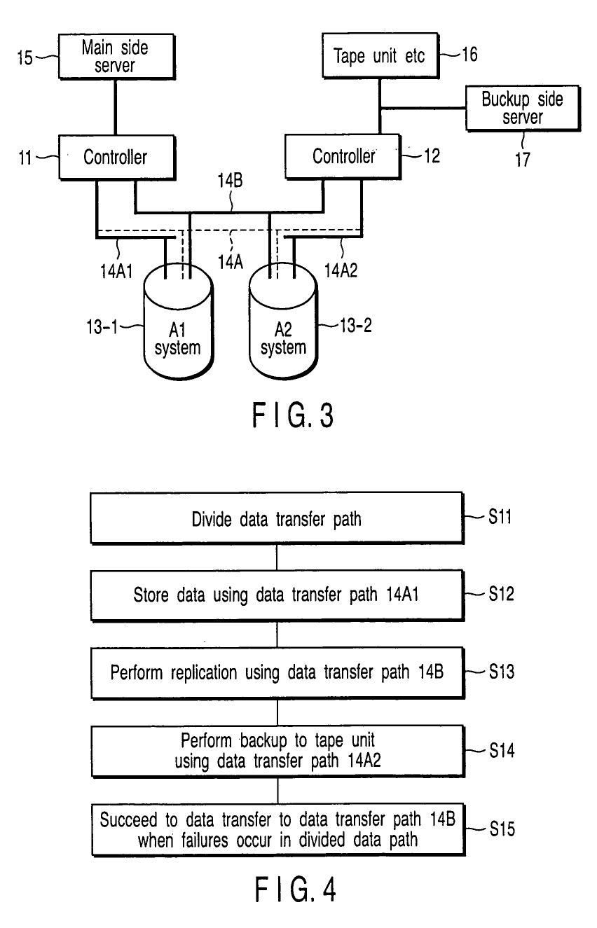

FIG. 3 is a block diagram depicting a configuration of a disk array system to which a data transfer method according to a first embodiment of the present invention is applied.

The disk array system shown in FIG. 3 comprises: a controller unit having a plurality of controllers 11 and 12; and an A1 system HDD 13-1 and an A2 system HDD 13-2 each having two ports for data transfer paths. The controllers 11 and 12, as described later in detail, divide a data transfer path 14A from two data transfer paths 14A (indicated by the dashed line) and 14B (solid line) connected to the two ports of the HDD 13-1 and the HDD 13-2, and achieve the sharing of the HDDs 13-1 and 13-2 by using the other data transfer path 14B. The controller unit is configured with the plurality of controllers, but in the embodiment of the present invention, it will be explained as an controller having a redundancy.

As described previously, if the two data transfer paths 14A and 14B connected to the two ports of the HDD 13-1 and the HDD 13-2 are completely disconnected from each other, the plurality of HDDs 13-1 and 13-2 cannot be shared between the controllers 11 and 12, as described previously. Thus, a normal original data configuration cannot be restored if a failure occurs.

Therefore, in the present embodiment, the A1 system HDD 13-1 and the A2 system HDD 13-2 having two ports do not share the two data transfer paths 14A and 14B connected to two ports of the plurality of HDDs 13-1 and 13-2. One of the data transfer paths, for example, 14A, is divided to make two divided data transfer paths 14A1 and 14A2, whereas the other data transfer path 14B is connected so as to be sharable between the plurality of controllers 11 and 12 without being divided.

In FIG. 3, a server 15 is provided as a main side server 15 which functions as a host unit. A LAN or an open network, etc. is connected to the server 15, although not shown. A tape unit, etc. 16 stores the data copied to the HDD 13-2 as backup data under the backup processing of a backup controller 12. A backup side server 17 is connected as required.

A data transfer method of the disk array system according to the present embodiment executes a series of processings as shown in FIG. 4.

(A) When data is transferred by using the data transfer paths of the plurality of HDD 13-1 and HDD 13-2 each having two ports, one data transfer path 14A is divided (S1). For example, in the case where the data transfer path is used in a multi-purpose manner in the disk array system, a transfer path dividing switch (not shown) is installed in the data transfer path 14A, thereby making it possible for the controller 11 to easily carry out divisional setting upon a request from the server 15.

(B) In this state, the controller 11 stores data in the HDD 13-1 via the divided data transfer path 14A1 in response to the request from the server 15 (S12).

(C) Continuously, the controller 11 reads out data from the HDD 13-1 and copies the readout data to the HDD 13-2 by using the data transfer path 14B (S13). In this manner, replication of the data stored in the HDD 13-1 is executed.

(D) The controller 12 reads out the data copied to the HDD 13-2 and backs up the readout data in the tape unit 16 by using the divided data transfer path 14A2 (S14).

In the data transfer method according to the present embodiment, when a large amount of data is transferred to the HDD 13-1 and when data is transferred from the HDD 13-2 to the tape unit 16, data transfer is carried out by using the divided data transfer paths 14A1 and 14A2 obtained by dividing one data transfer path 14A. In addition, the data transfer path 14B carries out the state monitoring of the HDD 13-1 and the HDD 13-2 between the controllers 11 and 12 and the sharing of management information including replication.

(E) In the data transfer path configuration as described above, for example, in the case where a failure occurs with the data transfer path 14A1 or the data transfer path 14A2, as is the case with a failure with the data transfer path 14A before divided, processing is inherited by using the data transfer path 14B (S15), thereby making it possible to continue the processing.

In the data transfer method according to the first embodiment, when data is transferred by using the data transfer paths of the plurality of HDD 13-1 and HDD 13-2 each having two ports, one data transfer path 14A is divided, making it possible to transfer a large amount of data, and the other data transfer path 14B can be shared between the controllers 11 and 12. In this manner, the data transfer paths 14A and 14B before divided are provided as the data transfer paths 14A1, 14A2, and 14B after divided, thereby making it possible to improve data transfer capability by 1.5 times.

Further, even in the case where a failure occurs with the data transfer path 14A1 or the data transfer path 14A2, processing can be continued by using the other data transfer path 14B.

### Second Embodiment

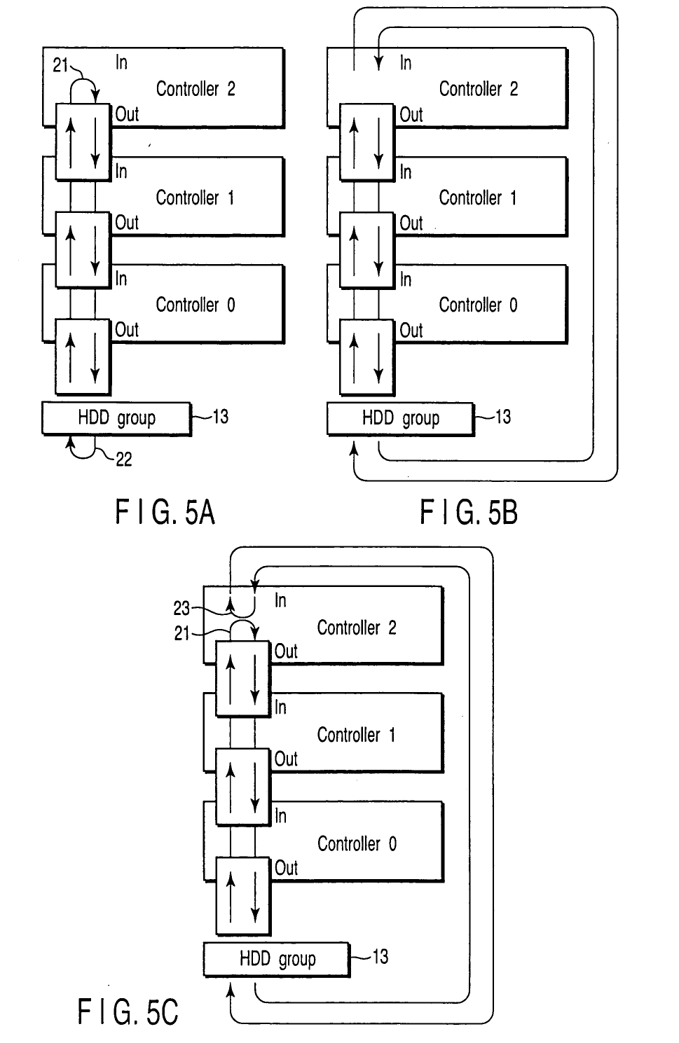

Referring now to FIGS. 5A to 7, a description will be given with respect to a data transfer method of a disk array system according to a second embodiment of the present invention.

The second embodiment describes an example of a configuration in which an HDD can be seen in the same state from a plurality of controllers if a failure occurs. Instead of a plurality of controllers, a plurality of controller units having a plurality of controllers may be configured. For clarity, the present embodiment describes a configuration of a plurality of controllers. It is possible to consider that the above configuration corresponds to a configuration similar to that of the plurality of controller units, and similar interpretation is established in the scope of the invention. Namely, this means that a plurality of controllers includes a plurality of controller units.

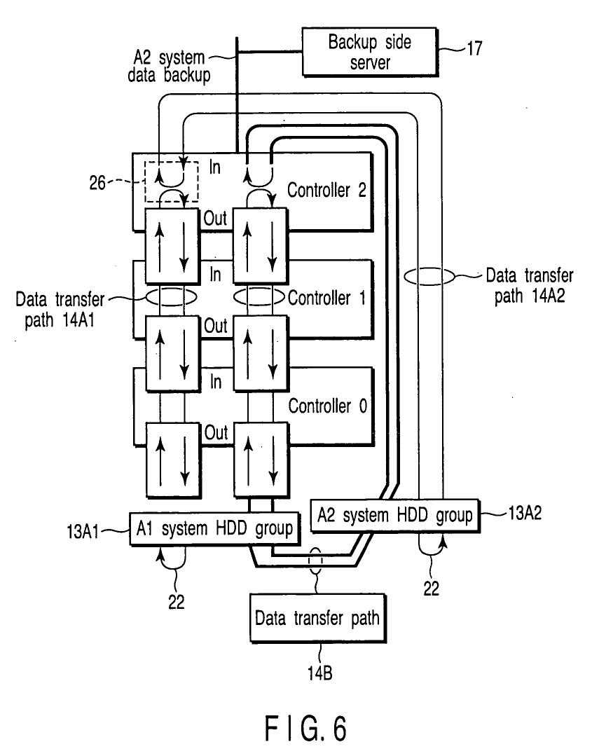

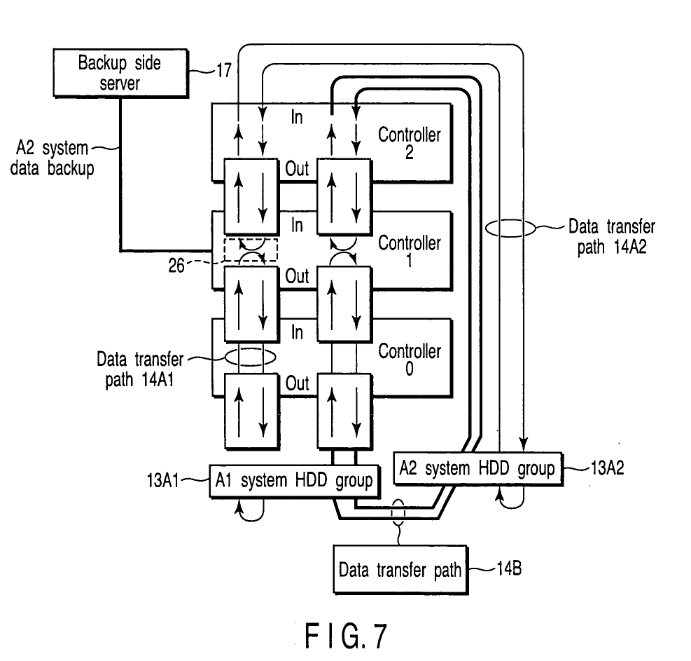

FIGS. 5A to 5C each show an example of utilizing two data transfer paths A and B connected to two ports of an HDD without being divided. A system A has a common configuration as a system B. Here, a description will be given without discriminating these systems from each other in particular. FIGS. 6 and 7 each show an example of applying the present invention to the configuration shown in FIG. 3 in which one data transfer path A is divided.

In a configuration including a plurality of controllers 0, 1, and 2 and an HDD group 13, if all the controllers 0, 1, and 2 are simply connected and looped, there are provided configurations as shown in FIGS. 5A and 5B equivalently showing FIG. 5A. A plurality of controller units 0, 1, and 2 may be configured instead of the plurality of controllers 0, 1, and 2.

In FIGS. 5A to 5C, the controllers 0, 1, and 2 each comprises two connection ports for serial data transfer paths. The two ports each have an output and an input, and are connected to each other so that the serial data transfer paths are looped. The two connection ports are used for connection between a controller connection port and an HDD connection port.

At this time, there is provided a configuration of making daisy chain connection of the controllers 0, 1, and 2 by using the controller connection port. Here, a loop back section 21 is formed at the controller 2 serving as an end, and a loop back section 22 is formed with respect to an HDD serving as an end in the HDD group 13, whereby reciprocating path lines are configured. At this time, as shown in FIG. 5B, when the end controller 2 and the end HDD are connected to each other, only one-side path line of the reciprocating path lines is used because of a relationship between an input and an output.

However, when the HDD can be seen in the same state from each of the controllers 0, 1, and 2, data can be easily shared if a failure occurs. The connection position of the end controller 2, as shown in FIG. 5C, can be identified from an identification number allocated to each controller unit. In general, the loop back section 21 is set at the controller connection port of the controller 2 serving as an end, and the loop back section 23 is set the HDD connection port.

The configuration shown in FIGS. 5A to 5C as described above is provided as an example of utilizing two data transfer paths A and B connected to two ports possessed by an HDD without dividing one of them. As shown in FIG. 2, if the data transfer paths A and B are completely divided, data cannot be shared between the controllers 1 and 2. If a failure occurs, it becomes difficult to recover the failure.

In the data transfer method of the disk array system according to the second embodiment, as shown in FIG. 6, one data transfer path A including an HDD is divided into an A1 system and an A2 system (14A and 14B), and the other data path B (14B) can be utilized by the plurality of controllers 11 and 12 without dividing it. In this manner, the monitoring of an HDD and data sharing can be achieved among the controllers 0, 1, and 2.

In FIG. 6, the controllers 0, 1, and 2 each comprise two connection ports for data transfer paths. The two connection ports are used as a controller connection port and an HDD connection port. The controller connection port forms an end loop back section at an arbitrary controller (for example, controller 2) of the plurality of controllers 0, 1, and 2. While the controller 2 having the loop back section is defined as an interface, the controller connection port includes the plurality of controllers 2, 1, and 0 and an HDD group 13A1 connected to the data transfer path 14A1 by using the divided data transfer path 14A1, thereby making daisy chain connection. In addition, an HDD group 13A2 having a loop back section is connected to the divided data transfer path 14A2.

Further, the controller 0, 1, and 2 and all the HDD groups 13A1 and 13A2 are connected to the HDD connection port via the other data transfer path 14B. A backup output system is provided at the controller 2 having an end loop back section, and the backup server 17 and a tape unit (not shown) are connected thereto.

In an operation in the configuration of the disk array system shown in FIG. 6, a series of processings are executed in accordance with operating procedures shown in FIG. 4. A detailed description thereof is not given here because it is given in FIG. 4.

FIG. 7 shows an example in which a loop back section is provided at the controller 1 instead of the controller 2 shown in FIG. 6. In FIG. 6, a backup side server 17 and a tape unit (not shown) are connected to an output side of the controller 1.

With such a connection configuration shown in FIG. 7, more flexible design can be made.

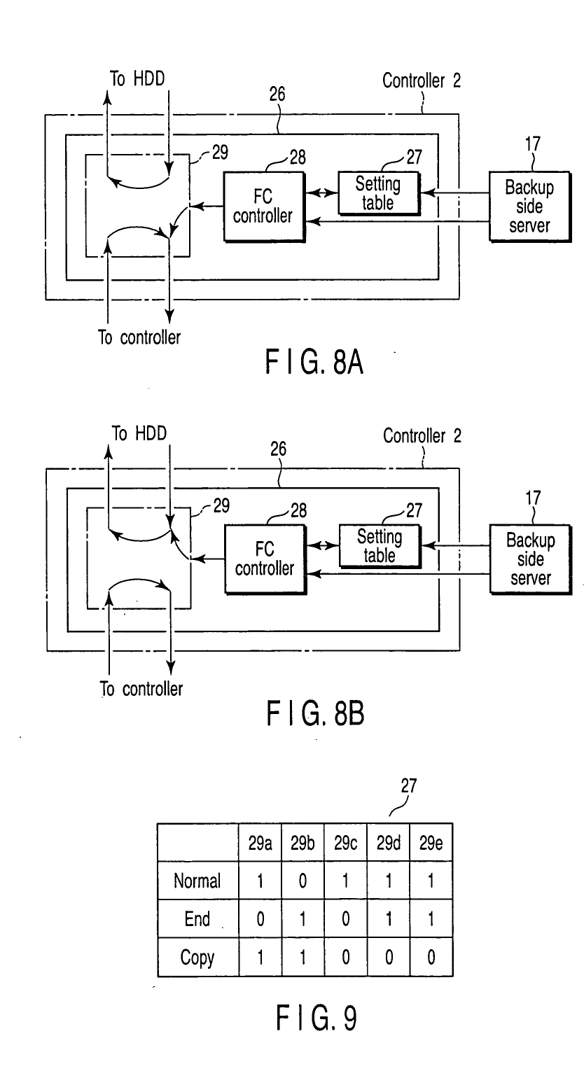

FIGS. 8A and 8B are schematic block diagrams depicting a loop back circuit 26 serving as the loop back section incorporated in the controller 2 of FIG. 6, for example. The loop back circuit 26 is also incorporated in the controllers 0 and 1 as required, as well as in the controller 2. In addition, in FIG. 7, the loop back circuit 26 is incorporated in at least the controller 1.

The loop back circuit 26 has: a setting table 27 for storing set data relating to a loop, the data being set from the backup side server 17; an FC controller 28 for outputting a division or connection control based a request from the backup side server 17 and the set data contained in the setting table 27 according to the request; and an FC loop divider 29 for carrying out loop division (or connection) based on the division or connection control signal from the FC controller 28.

The setting table 27, as shown in FIG. 9, is provided as a table for storing set data for carrying out normal loop setting, end loop setting, and copy loop setting relevant to the corresponding controller 2.

The FC controller 28 has, for example, a register or the like incorporated therein, and has the following function. Having received normal loop setting from the backup side server 17, the FC controller captures normal setting data from a normal loop setting area of the table 27, stores the captured data in the register, and then, makes division or connection control in accordance with the contents of the register. Alternatively, having received a request for setting a normal loop from the backup side server 17, the FC controller captures normal setting data from the normal loop setting area of the table 27 and makes division or connection control.

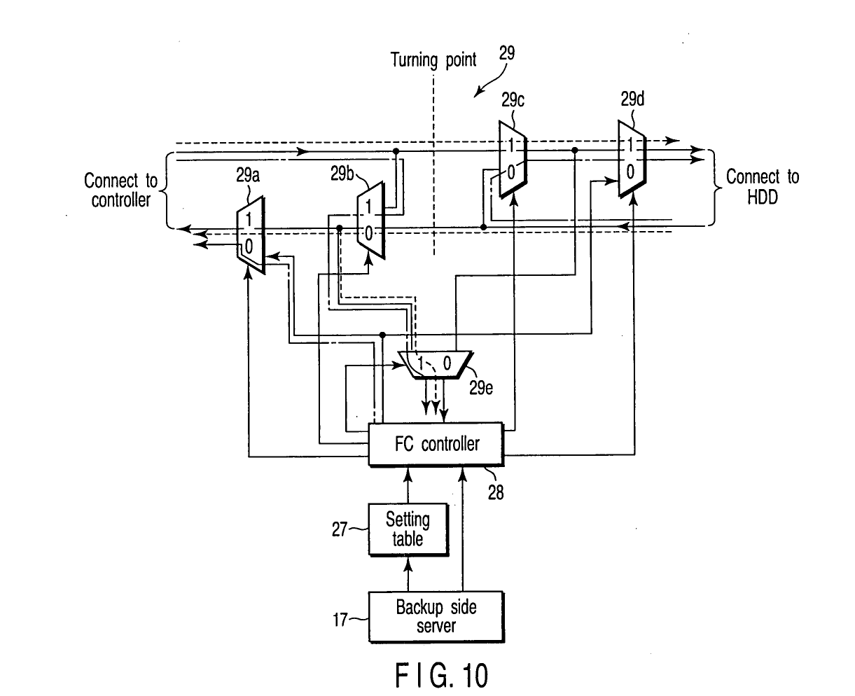

Specifically, the FC loop divider 29, as shown in FIG. 10, has a combination circuit of bypass devices 29a, 29b, 29c, 29d, and 29e called port bypass circuits. The divider generates a constituent element which incorporates an HDD or an HDD unit in a loop or which eliminates them from the loop. Therefore, a data transfer path can be divided by using the bypass devices 29a, 29b, 29c, 29d, and 29e.

Now, a description will be given with respect to an example of carrying out normal loop setting, end loop setting, and copy loop setting by using the FC loop divider 29 in accordance with the contents set in the setting table 27.

(1) Normal Loop Setting (Dashed Line)

The FC controller 28 having received a request for normal loop setting from the backup side server 17 connects either of “0” and “1” of the bypass devices 29a, 29b, 29c, 29d, and 29e based on the normal setting data contained in the register or setting table 27 described previously, and sets a route as the illustrated line. Namely, a route of “1” from the controller side to device 29c→“1” of device 29d→HDD; a route of HDD→“0” of device 29b→“1” of device 29a→controller; and a route of HDD→“0” of device 29b→“1” of device 29e→FC controller 28 are formed, and the controller and the HDD are connected to each other.

(2) End Loop Setting (Alternate Dot and Chain Line)

The FC controller 28 having received a request for end loop setting from the backup side server 17 connects either of “0” and “1” of the bypass devices 29a, 29b, 29c, 29d, and 29e based on the end setting data contained in the register or setting table 27 described previously, and sets a route indicated by the dashed line.

(3) Copy Loop Setting

A copy loop is set in accordance with the contents set in the setting table 27 in the same way as in the normal loop setting and end loop setting described previously.

According to the second embodiment, the FC controller includes the plurality of controllers and the HDD group connected to the divided data transfer paths by using two divided data transfer paths. This controller makes daisy chain connection while an end portion is provided as a loop back section. Furthermore, the FC controller connects the controllers and all the HDD groups by using the other data transfer path. In this manner, data can be shared between the controllers. In addition, each of the controllers can be used for state monitoring of a plurality of HDDs via the other data transfer path and data management including replication of data stored in each of the HDDs. If a failure occurs with either of the divided data transfer paths, processing can be inherited by using the other data transfer path.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk array system comprising:
first and second transfer paths;
a plurality of hard disks each having two connection ports connected to the first and second transfer paths, respectively; and
a plurality of controllers connected to the first and second transfer paths,
wherein the first transfer path is connected to the plurality of hard disks and the plurality of controllers in common, and
the second transfer path is divided as a transfer path for individual data transfer between the plurality of controllers and the plurality of hard disks.

2. A disk array system according to claim 1,
wherein the first transfer path is used for state monitoring of the plurality of hard disks shared among the plurality of controllers and replication of data stored in each of the hard disks, and
the second transfer path is used for transferring a large amount of data to each of the controllers.

3. A disk array system according to claim 1,
wherein the plurality of controllers each comprises first and second connection ports, the first and second connection ports being used as a port for making connection to another controller and a hard disk connection port,
a first connection port of one controller of the plurality of controllers configures an end loop back section, and the plurality of controllers and the plurality of hard disks connected to the first transfer path are daisy-chain connected to each other by a first connection port of another controller of the plurality of controller; and
the plurality of controllers and the plurality of hard disks are connected via the second transfer path by the second connection port of the plurality of controllers.

4. A disk array system according to claim 3, wherein the controller having the loop back section is connected to a backup system, and functions as a backup controller.

5. A data transfer method to be applied to a disk array system in which a plurality of controllers share a plurality of hard disks each having first and second connection ports, the method comprising:
dividing a first connection port of first and second data transfer paths independently connected to the first and second connection ports of the plurality of hard disks, respectively, the first connection port of the plurality of hard disk and the plurality of controllers being independently connected, respectively, via the first data transfer path,
wherein, the first data transfer path is used for the controllers to transfer a large amount of data, respectively, and
the second data transfer path is used for state monitoring of the plurality of HDDs shared among the controllers and replication of data stored in each of the HDDs.

6. A data transfer method according to claim 5,
wherein the a plurality of controllers each include first and second controllers,
the plurality of hard disks each include first and second hard disks,
the first controller connected to a first divided data transfer path of the first data transfer path after divided stores data in the first hard disk connected to the first divided data transfer path;
the first controller copies data stored in the first hard disk to the second hard disk connected to the second data transfer path; and
the second controller connected to a second divided data transfer path of the second data transfer path after divided reads out data copied to the second hard copy, and performs backup transferring the readout data using the second divided data transfer path.
